(19) United States
(12) Patent Application Publication
(10) Pub. No.: US 2025/0091891 A1
(43) Pub. Date: Mar. 20, 2025

(54) METHOD FOR THE PRODUCTION OF ALUMINIUM HYDROXIDE FROM BAUXITE

(71) Applicant: Metlen Energy & Metals S.A., Ag. Nikolaos (GR)

(72) Inventors: David KONLECHNER, Wien (AT); Efthymios BALOMENOS, Zografou (GR); Danai MARINOS, Athens (GR); Michail VAFEIAS, Athens (GR)

(21) Appl. No.: 18/728,377

(22) PCT Filed: Oct. 7, 2022
(86) PCT No.: PCT/AT2022/060350

§ 371 Date: Jul. 11, 2024

(30) Foreign Application Priority Data
Jan. 14, 2022 (AT) A60009/2022

(51) Int. Cl. C01F 7/441

(52) U.S. Cl. CPC C01F 7/441; C01P 2004/61

(57) ABSTRACT

A method for the production of aluminium hydroxide (Al(OH)3) is described wherein in a first tank a first aqueous solution of sodium aluminate (NaAl(OH)4) is provided and carbon dioxide (CO2) gas is added to the first tank to form a first aluminium hydroxide precipitate, and wherein a second tank containing a second aqueous solution of sodium aluminate is provided, wherein the sodium aluminate solution in the second tank is supersaturated and seed crystals are added to the second tank to form a second aluminium hydroxide precipitate. At least a fraction of the first aluminium hydroxide precipitate obtained from the first solution in the first tank is seeded into the second tank and/or at least a fraction of the second aluminium hydroxide precipitate obtained from the second solution in the second tank is seeded into the first tank.

### CROSS REFERENCE

This application is a U.S. National Phase Application of International Application No. PCT/AT2022/060350 filed Oct. 7, 2022, which claims the priority of Austrian Patent Application No. A60009/2022 filed Jan. 14, 2022, the entire disclosures of each of which are hereby incorporated by reference.

### TECHNICAL FIELD

The present disclosure relates to a method for the production of aluminium hydroxide. Particularly the present disclosure relates to a method to increase the yield of aluminium hydroxide or aluminium oxide from bauxite.

### BACKGROUND

The economically most important raw material for the production of aluminium is bauxite.

The extraction of aluminium from bauxite is usually carried out in the Bayer process. Typically, bauxite ores are rich both in aluminium and iron oxides. The ores are leached with a sodium hydroxide solution (NaOH) in order to dissolve aluminium as sodium aluminate. Aluminium hydroxide can be precipitated from this sodium aluminate solution. The precipitated Aluminium hydroxide can be calcinated to obtain aluminium oxide, also known as alumina, which can be further processed via the Hall-Heroult process to aluminium metal.

After dissolving the aluminium content from bauxite as sodium aluminate, a large amount of bauxite residue is produced, also known as red mud due to its red colour originating from the richness in iron oxides. It also contains still some aluminium and other undissolved metals. Red mud often has high calcium and sodium hydroxide content with a complex chemical composition, and accordingly is very caustic and a potential source of pollution. Red mud is often stored in large reservoirs, involving the risk of a dam bursting with potentially catastrophic consequences. Alternatively, red mud can be stored by dry stacking after filter pressing.

In the 1920s, another process for aluminium production was developed and successfully implemented in Norway, called the Pedersen process. The Pederson process does not require bauxite as raw material, but allows the treatment of rocks with aluminium in the form of various compositions. In the first step, the raw material containing aluminium is mixed with limestone, and coke. The mixture is melted and fed into a submerged arc furnace (SAF). This step involves slag design and pig iron production.

By electrical smelting, pig iron can be initially separated and can be used as an additional product. During the smelting a slag containing calcium aluminate is generated. Leaching this slag produces a solution containing aluminium and a solid called grey mud. The Pederson process allows aluminium extraction by using less aggressive chemicals such as sodium carbonate (Na2CO3). After the leaching step, carbon dioxide (CO2)-driven precipitation leads to the formation of aluminium hydroxide.

The Pederson process was in operation from 1928 to 1969 on an industrial scale but was finally closed due to economic reasons. Although this process requires a lot of electric energy, it is still more environmentally friendly, as the Pedersen process generates valuable pig iron and grey mud as side products. Grey mud contains mainly calcium carbonate (CaCO3), also known as limestone, which can be used in different applications. As a result, the Pedersen process has been the subject of some recent research:
David Konlechner et al., First Industrial Scale Process Concept for the Reengineered Pedersen Process within ENSUREAL, Materials Proceedings 2021, 5, 8.
Adamantia Lazou et al., The utilization of bauxite residue with a calcite-rich bauxite ore in the Pedersen Process for iron and alumina extraction. 2020.
Adamantia Lazou et al., High Temperature Treatment of Selected Iron Rich Bauxite Ores to Produce Calcium Aluminate Slags, Materials Proceedings 2021, 5, 36.
Fabian Imanasa Azof, Pyrometallurgical and Hydrometallurgical Treatment of Calcium Aluminate-containing Slags for Alumina Recovery, PhD, Norwegian University of Science and Technology, 2020.
Fabian Imanasa Azof, Leiv Kolbeinsen, Jafar Safarian, The Leachability of Calcium Aluminate Phases in Slags for the Extraction of Alumina. In Proceedings of the 35th International ICSOBA Conference, Hamburg, 2017.
Fabian Imanas Azof et al., The leachability of a ternary CaO-AI203-SiO2 slag produced from smelting-reduction of low-grade bauxite for alumina recovery, Hydrometallurgy 2020, 191, 105184, doi: https://doi.org/10.1016/j.hydromet.2019.105184.
Michael Vafeias et al., Leaching of Ca-Rich Slags Produced from Reductive Smelting of Bauxite Residue with Na2CO3 Solutions for Alumina Extraction: Lab and Pilot Scale Experiments. Minerals 2021, 11, 896.
Michail Vafeias et al., Alkaline alumina recovery from bauxite residue slags; 2020.
Danai Marinos et al., Parameters Affecting the Precipitation of Al Phases from Aluminate Solutions of the Pedersen Process: The Effect of Carbonate Content. Journal of Sustainable Metallurgy 2021, 7, 874-882, doi: 10.1007/s40831-021-00403-w.

It has already been reported that the bauxite residue generated by the Bayer process can be used as raw material for the Pedersen process. However, the carbon dioxide precipitation step is a challenging one. Aluminium hydroxide precipitates formed only by carbon dioxide addition do not have the properties for industrial usage of this product.

Therefore, the technical problem is to provide a process for the production of aluminium that is economical on an industrial scale and environmentally friendly.

### SUMMARY

For a method for the production of aluminium hydroxide (AI(OH)3), wherein in a first tank a first aqueous solution of sodium aluminate (NaAI(OH)4) is provided and carbon dioxide (CO2) gas is added to the first tank to form a first aluminium hydroxide precipitate, and wherein a second tank containing a second aqueous solution of sodium aluminate is provided, wherein the sodium aluminate solution in the second tank is supersaturated and seed crystals are added to the second tank to form a second aluminium hydroxide precipitate it is provided that at least a fraction of the first aluminium hydroxide precipitate obtained from the first solution in the first tank is seeded into the second tank and/or at least a fraction of the second aluminium hydroxide precipitate obtained from the second solution in the second tank is seeded into the first tank.

The present disclosure overcomes the bauxite residue problem of the Bayer process and the economic challenges of the Pedersen process, merging both processes uniquely. The present disclosure makes it possible to provide a high-quality aluminium hydroxide also via the Pederson process and to reduce the investments necessary to implement the processing of the bauxite residue. It is possible to implement the process according to the present disclosure in a single facility for the processing of the aluminium hydroxide precipitate from the Bayer side and the aluminium hydroxide precipitate from the Pederson side. The present disclosure also provides the possibility of jointly using existing equipment of plants operating according to the Bayer process and obtaining higher yields from the same input feed of bauxite.

At first Bauxite is heated along with sodium hydroxide solution, and aluminium is dissolved as sodium aluminate and the solution is transferred to the second tank.

The bauxite residue is separated from the solution. The bauxite residue is then mixed with limestone and coke and the mixture is subjected to smelting to extract pig iron and to form a slag. The slag is mixed with sodium carbonate and aluminium is dissolved as sodium aluminate from the slag, this solution is transferred to the first tank. Then the processes are combined according to the present disclosure.

The process of the present disclosure achieves a high yield of high-quality aluminium hydroxide that can easily be further processed to aluminium working material via the known process step such as calcination to aluminium oxide and the Hall-Heroult process. This novel approach increases the synergies of both processes generating ecologic and economic benefits, by achieving significantly higher alumina extraction rates. It further allows the extraction of pig iron from bauxite, generating a second value product.

A high quality product can be produced in a method, wherein the second precipitate is separated according to size, wherein aluminium hydroxide fines are separated out and crystallised aluminium hydroxide is obtained as product, in particular crystallised aluminium hydroxide, wherein at least 79 wt. % of the particles have a particle size of 0.15 mm (Tyler mesh 100) to 44 μm (Tyler mesh 325). The crystallised aluminium hydroxide can be further processed e.g. by calcinating the crystallised aluminium hydroxide to high quality aluminium oxide.

The synergies of the Bayer and the Pedersen processes can be used particularly effectively, when the entire first aluminium hydroxide precipitate is added to the second tank containing the second sodium aluminate solution.

Only minor adjustments in the usual Bayer process are necessary, when the first precipitate is added to the second tank to form the supersaturated solution of sodium aluminate. In this way, the advantages of the Pedersen method can be used effectively without much effort and without major adjustments.

Another way to effectively utilise the advantages of both methods is that the second tank contains the supersaturated solution of sodium aluminate and the first precipitate is used for seeding to support precipitation in the second tank. In addition, or alternatively a fraction from the second precipitate can be used for seeding to support precipitation in the second tank.

In order to enable relatively swift precipitation in the first tank, which nevertheless provides aluminium hydroxide of high quality, it can be provided that at least a fraction of the second precipitate is seeded into the first tank.

The precipitation in the first tank is improved, when after the separation of the second precipitate according to size at least a fraction of the aluminium hydroxide fines is seeded into the first tank.

To improve precipitation in the first tank, a method is provided, wherein after separation of the second precipitate according to size a fraction of the product particles is seeded into the first tank. In this embodiment crystallised aluminium hydroxide is obtained from the second tank and further crystallised aluminium hydroxide is obtained from the first tank.

High-quality aluminium hydroxide is obtained in a method, wherein the first precipitate is separated according to size, wherein aluminium hydroxide fines are separated out and a further crystallised aluminium hydroxide is obtained as a product, in particular, a further crystallised aluminium hydroxide, wherein at least 79 wt. % of the particles have a particle size of 0.15 mm (Tyler mesh 100) to 44 μm (Tyler mesh 325).

The present disclosure is further directed to a method for the production of aluminium oxide, wherein aluminium hydroxide is obtained as described before, and wherein the aluminium hydroxide is calcinated.

High-quality aluminium oxide can be provided, when crystallised aluminium hydroxide is used.

The calcination usually carried out in a facility using the Bayer process does not need to be adjusted, if crystallised aluminium hydroxide obtained from the second tank is calcinated.

The minimum changes to the process flow in a plant designed for the Bayer Process are required when at least a fraction of the first precipitate is calcinated, in particular the further crystallised aluminium hydroxide.

To improve precipitation in the first tank, aluminium hydroxide fines contained in the gas stream exiting the calciner are added to the first tank. As aluminium hydroxide fines exiting the calciner are dry, they are particularly suitable for addition to the solution in the first tank.

In addition, or alternatively, aluminium hydroxide fines contained in the gas stream exiting the calciner can be added to the second tank.

According to a further aspect of the present disclosure a plant or an arrangement for the production of aluminium hydroxide or aluminium oxide is provided, wherein the plant has a first tank containing a solution of sodium aluminate, wherein the first tank is provided with means for sparging the solution with carbon dioxide, and wherein the plant has a second tank containing a supersaturated solution of sodium aluminate, wherein the first and the second tank are connected in such a way, that at least a fraction of the precipitate obtained from the first tank can be added to the second tank and/or that at least a fraction of the precipitate obtained from the second tank can be added to the first tank.

In particular the first tank and/or the second tank is connected to separation means for separating the precipitates according to size, wherein the separation means are connected to the first tank and/or the second tank.

It may also be provided that the plant contains a calciner and the calciner has a blowout that is connected to the first tank and/or second tank.

These and other aspects are merely illustrative of the innumerable aspects associated with the present disclosure and should not be deemed as limiting in any manner. These and other aspects, features, and advantages of the present disclosure will become apparent from the following detailed description when taken in conjunction with the referenced drawings.

### BRIEF DESCRIPTION OF THE FIGURES

Reference is now made more particularly to the drawings, which illustrate the best presently known mode of carrying out the present disclosure and wherein similar reference characters indicate the same parts throughout the views.

FIG. 1 shows a process diagram according to an embodiment A.

FIG. 2 shows a process diagram according to an embodiment B.

FIG. 3 shows a process diagram according to an embodiment C.

FIG. 4 shows a process diagram according to an embodiment D.

FIG. 5 shows a process diagram summarizing the material stream of a process according to the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

In the following detailed description numerous specific details are set forth in order to provide a thorough understanding of the present disclosure. However, it will be understood by those skilled in the art that the present disclosure may be practiced without these specific details. For example, the present disclosure is not limited in scope to the particular type of industry application depicted in the figures. In other instances, well-known methods, procedures, and components have not been described in detail so as not to obscure the present disclosure.

The headings and sub-headings used herein are intended only for general organization of topics within the present disclosure and are not intended to limit the disclosure of the technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Detailed Description” section of this specification are hereby incorporated by reference in their entirety.

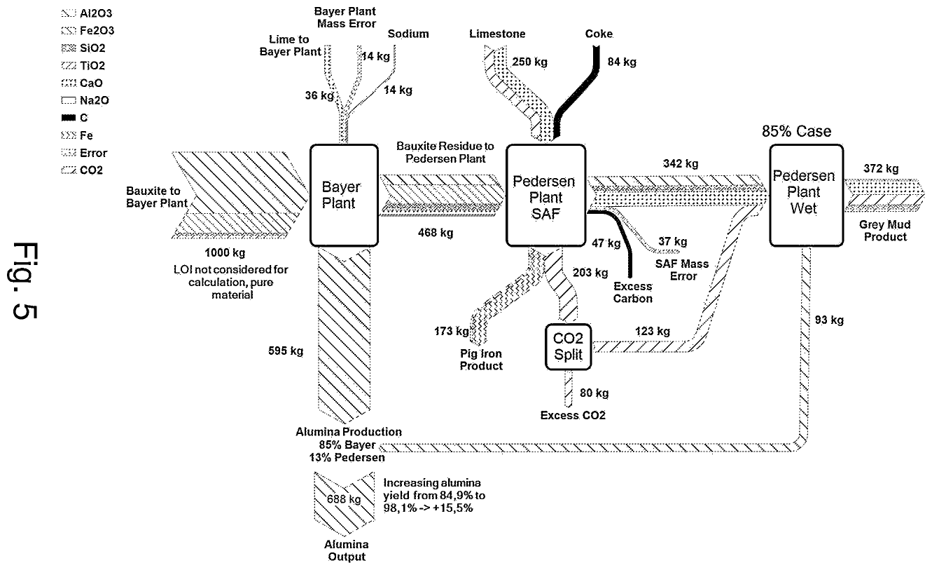

FIG. 5 shows the interaction of the Bayer process and the Pedersen Process as disclosed herein. The Bayer process is used for the extraction of the main fraction of aluminium from bauxite, while the Pedersen process is used for the extraction of aluminium from the bauxite residue generated by the Bayer process. To provide a high-quality aluminium hydroxide also via the Pederson process and to reduce the investments necessary to implement the processing of the bauxite residue, it is suggested to provide a single facility for the processing of the aluminium hydroxide precipitate from the Bayer side and the aluminium hydroxide precipitate from the Pederson side.

In every Example A, B, C and D a method for the production of high quality crystallised aluminium hydroxide (AI(OH)3) is provided. The Pedersen side of the facility contains a first tank containing a first aqueous solution of sodium aluminate (NaAI(OH)4).

Preferably the sodium aluminate solution has a temperature range between 40° C. and 90° C. Carbon dioxide (CO2) gas is added to the first tank, e.g. by sparging. The gas stream may contain other gases or water vapor as well. In the first tank the first aluminium hydroxide precipitate is formed, and a yield of 70 to 99% is possible. Sodium carbonate and water are generated as additional products. The first precipitate can be separated from the aqueous sodium carbonate solution by known solid/liquid separation technologies.

The Bayer side of the facility contains a second tank containing a second aqueous solution of sodium aluminate. The sodium aluminate solution in the second tank is supersaturated and seed crystals are added to the second tank to form a second aluminium hydroxide precipitate. The second precipitate can be separated according to particle size, e.g. by hydrocyclone sizing and/or filtration.

The present disclosure discloses that at least a fraction of the first aluminium hydroxide precipitate obtained from the first solution in the first tank is seeded into the second tank. In addition, or alternatively, at least a fraction of the second aluminium hydroxide precipitate obtained from the second solution in the second tank is seeded into the first tank.

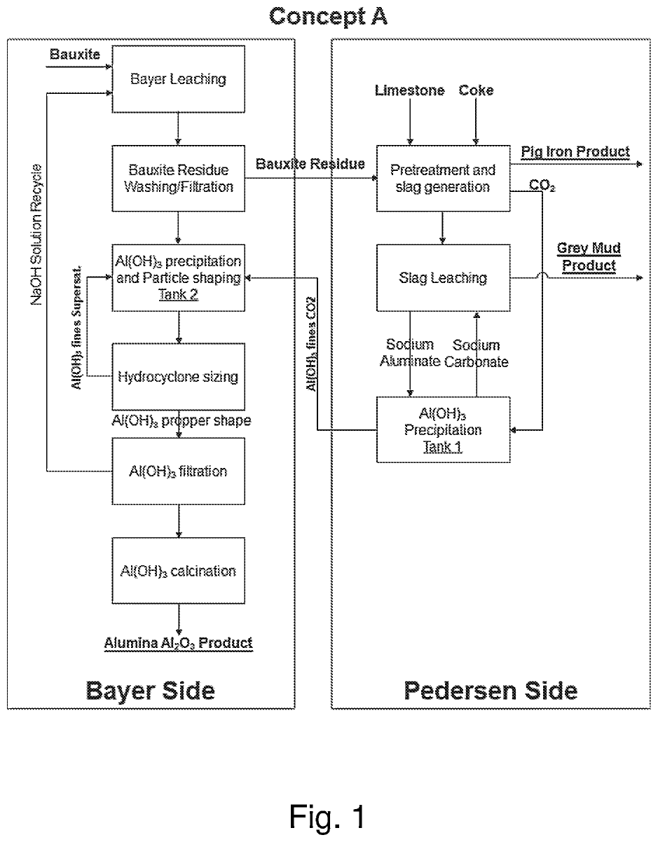

FIGS. 1 to 4 show the interactions of the crystallisation steps according to the examples.

### Example A

FIG. 1 shows an embodiment of the present disclosure, wherein the first precipitate from the first tank is added to the second tank.

In this specific process 50.6 t/h slag at 80° C. containing 40.1% 12CaO-7Al2O3 is initially mixed with 670.4 t/h of a 40° C. 16.7 wt % Na2CO3 solution in a digestion tank. To maintain an alkaline environment and avoid AI(OH)3 precipitation, a 3.3 t/h Na2CO3 solid stream at 70° C. is also added. The mixture is heated up to 80° C. to leach out Al2O3 as NaAI((OH)4, while calcium precipitates as CaCO3. The saturated 688.5 t/h leach solution at 80° C. containing 5.0 wt. % NaAI(OH)4 is then directed to the first tank for precipitation. In the first tank, an 80° C. 10.2 t/h CO2 stream is added to neutralize the solution and a first AI(OH)3 precipitate is generated. The first AI(OH)3 precipitate is separated from the 670.4 t/h liquid phase containing Na2CO3, water and NaAI(OH)4 into a 22.6 t/h 40° C. AI(OH)3 dry solid phase. The separated solution is redirected to the digestion tank and the solid phase is further washed to remove any remaining soluble compounds.

The first precipitate is added to the second tank and a further crystallisation step is performed. In the second tank a second NaAI((OH)4 solution is contained. The NaAI((OH)4 solution is supersaturated and seed crystals are added to initiate precipitation of a second precipitate of crystalized AI(OH)3. The first precipitate is added to the supernatant NaAI((OH)4 solution. The second precipitate is separated by hydrocyclone sizing and filtration. AI(OH)3 fines are separated out and added to the second tank. Crystallised AI(OH)3 product particles reaching the following physical properties typical for an AI(OH)3 applicable for industrial alumina production:

Physical property

| Particle size distribution, wt % | |
|---|---|
| +100 mesh (Tyler) | <5 |
| +325 (44 μm) | >92 |
| −325 | <8 |
| Bulk density, kg/L | |
| loose | 0.95-1.00 |
| packed | 1.05-1.10 |
| Specific surface area, m²/g | 50-80 |
| Moisture (to 573 K), wt % | <1.0 |
| Loss on ignition (573-1473 K), | <1.0 |
| wt % | |
| Attrition index (modified | increase in <44 μm particles |
| Forsythe-Hertwig method) | 4-15 wt % |
| α-Al₂O₃ content (by optical or | <20 |
| X-ray method), % | |
| Chemical analysis | wt % |
| Fe₂O₃ | <0.015 |
| SiO₂ | <0.015 |
| TiO₂ | <0.004 |
| CaO | <0.040 |
| Na₂O | <0.400 |

In this example, the yield increases by 22.6 t/h AI(OH)3.

### Example B

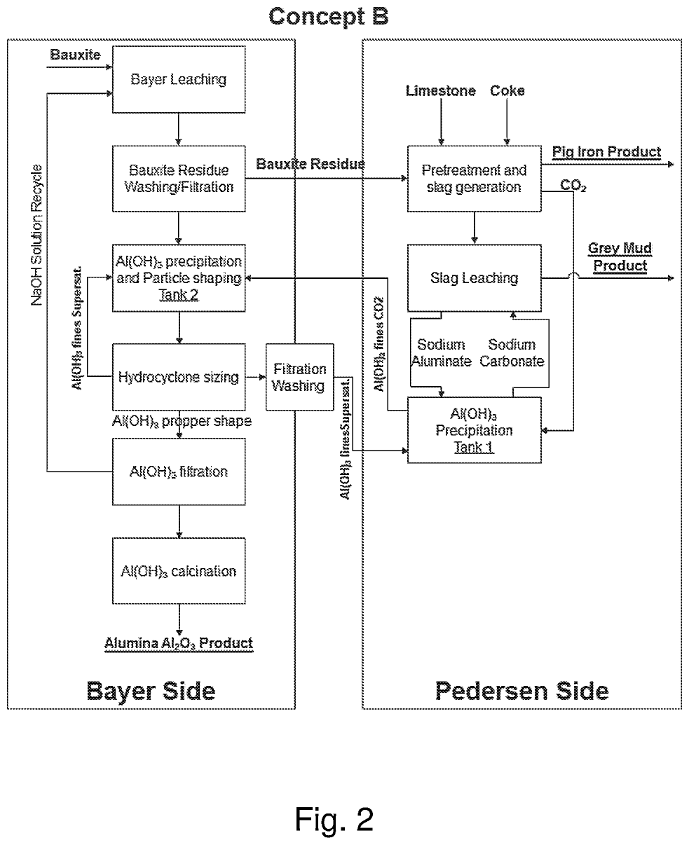

FIG. 2 shows an embodiment of the present disclosure, wherein the first precipitate is added to the second tank and a fraction of the second precipitate is added to the first tank, in particular the aluminium hydroxide fines separated out from the second precipitate are seeded to the first tank.

The process in Example B is mostly the same as in Example A. However, 20 t/h of AI(OH)3 fines are added to the first tank before sparging and the CO2 stream has a temperature of 65° C. This initiates the formation of larger size particles in the first precipitate.

### Example C

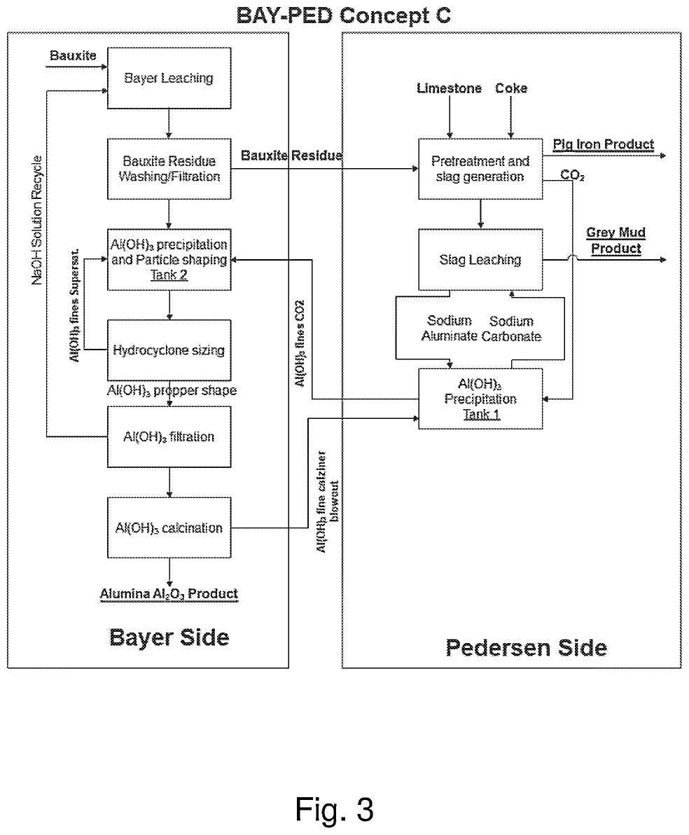

FIG. 3 shows an embodiment of the present disclosure, wherein the first precipitate is added to the second tank and a fraction of the second precipitate is added to the first tank, in particular the aluminium hydroxide fines contained in the blowout of a calciner used to calcinate the crystallised aluminium hydroxide separated from the second precipitate.

The process in Example C is mostly the same as in Example B. However, instead of adding AI(OH)3 fines directly separated out from the second precipitate, AI(OH)3 fines contained in the blowout of a calciner are used. This specific process has the advantage that the AI(OH)3 fines are dry and can be easily added to the first tank without any washing step.

### Example D

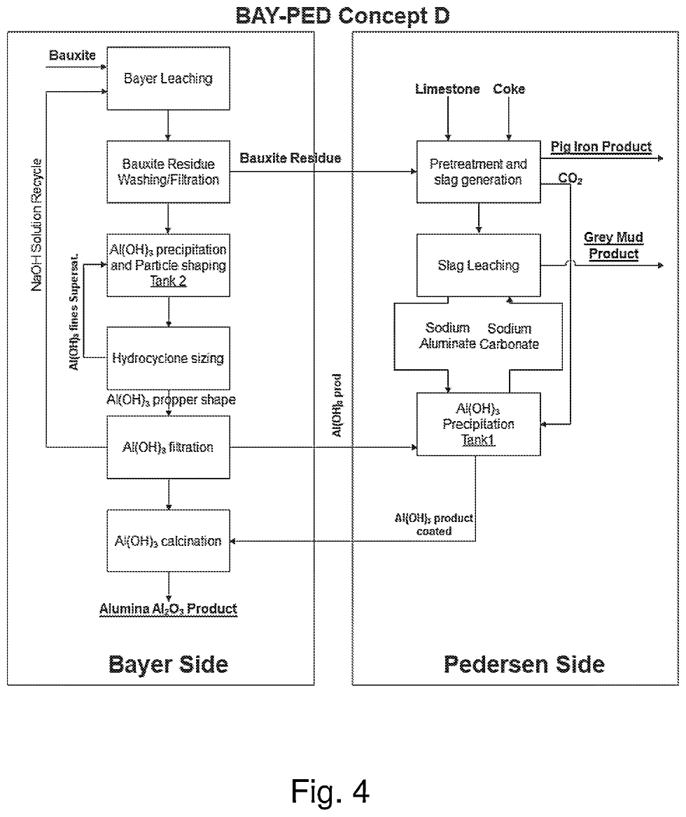

FIG. 4 shows an embodiment of the present disclosure, wherein a fraction of the second precipitate, in particular a fraction of the crystallised aluminium hydroxide product, is added to the first tank. In this example the first precipitate is further processed and together with the remaining product is calcinated.

In this specific process 50.6 t/h slag at 80° C. containing 40.1% 12CaO-7Al2O3 is initially mixed with 670.4 t/h of a 40° C. 16.7 wt % Na2CO3 solution in a digestion tank. To maintain an alkaline environment and avoid AI(OH)3 precipitation, a 3.3 t/h Na2CO3 solid stream at 70° C. is also added. The mixture is heated up to 80° C. to leach out Al2O3 as NaAI((OH)4, while calcium precipitates as CaCO3. The saturated 688.5 t/h leach solution at 80° C. containing 5.0 wt. % NaAI((OH)4 is then directed to the first tank for precipitation.

In the second tank a second AI(OH)3 precipitate is generated by adding AI(OH)3 fines to a supersaturated NaAI((OH)4 solution. 20 t/h of crystallised AI(OH)3 product obtained by separation of the second precipitate from the second tank is added to the first tank. A 65° C. 10.2 t/h CO2 stream is added to neutralize the solution and the first AI(OH)3 precipitate is generated in the first tank. The first AI(OH)3 precipitate is separated from the 670.4 t/h liquid phase containing Na2CO3, water and NaAI((OH)4 into a 22.6 t/h 40° C. AI(OH)3dry solid phase. The separated solution is redirected to the digestion tank and the solid phase is further washed to remove any remaining soluble compounds. The solid phase is further processed in a calciner together with the remaining crystallised aluminium hydroxide obtained from the second tank. The advantage of this process is, that the process of crystallisation on the Bayer side remains unchanged and no adjustments have to be made to the usual production method.

These examples show that the present disclosure provides the possibility of jointly using existing equipment of plants operating according to the Bayer process and obtaining higher yields from the same input feed of bauxite. In FIG. 5 it is assumed as reference that of 1000 kg bauxite used in a typical Bayer plant the bauxite residue amounts to 468 kg that is transferred to the Pederson side. It can be considered that the bauxite residue has the following composition: 38 wt. % Fe₂O3, 18 wt. % Al2O3, 19 wt. % rest (SiO2, TiO2, CaO, trace elements) and 25 wt. % remaining moisture. In this scenario 595 kg of Aluminium oxide are obtained from the Bayer side of the process and additional 93 kg of Aluminium oxide are obtained from the Pedersen side of the process. Additional products are 173 kg of pig iron and 372 kg of grey mud.

The economic investment for implementing the process according to the present disclosure only requires a few parts of a Pedersen plant adjacent to a Bayer plant. Considering an input stream of 800 000 t/a of bauxite residue, 230 000 t/a limestone, 40 000 t/a coke, 29 000 t/a sodium carbonate and 50 000 t/a quicklime are required. This provides an additional output of 125000 tons of aluminium hydroxide per year. Thus, the yield can be raised from 85% extraction of high-quality aluminium from bauxite via the Bayer process alone to 98% extraction of high-quality aluminium via the process according to the present disclosure. Further 210 000 t/a of pig iron are produced and 420 000 t/a of dry grey mud. The area for the additionally required process equipment is only about 410×180 m, so environmental impact is kept to a minimum.

Thus, the present disclosure provides an economically beneficial process as existing facilities can be used optimally and the yield of high-quality aluminium hydroxide from bauxite raw material is increased. At the same time, the process according to the present disclosure provides several useful products without the formation of large amounts of poisonous waste and thus, provides an environmentally friendly production process for aluminium.

The preferred embodiments of the disclosure have been described above to explain the principles of the present disclosure and its practical application to thereby enable others skilled in the art to utilize the present disclosure. However, as various modifications could be made in the constructions and methods herein described and illustrated without departing from the scope of the present disclosure, it is intended that all matter contained in the foregoing description or shown in the accompanying drawings, including all materials expressly incorporated by reference herein, shall be interpreted as illustrative rather than limiting. Thus, the breadth and scope of the present disclosure should not be limited by the above-described exemplary embodiment but should be defined only in accordance with the following claims appended hereto and their equivalents.

1. A method for the production of aluminium hydroxide (AI(OH)3), comprising the steps of:
wherein in a first tank a first aqueous solution of sodium aluminate (NaAI((OH)4) is provided and carbon dioxide (CO2) gas is added to the first tank to form a first aluminium hydroxide precipitate, and
wherein a second tank containing a second aqueous solution of sodium aluminate is provided, wherein the sodium aluminate solution in the second tank is supersaturated and seed crystals are added to the second tank to form a second aluminium hydroxide precipitate,
characterized in that at least a fraction of the first aluminium hydroxide precipitate obtained from the first solution in the first tank is seeded into the second tank and/or at least a fraction of the second aluminium hydroxide precipitate obtained from the second solution in the second tank is seeded into the first tank.

2. The method according to claim 1, wherein the second precipitate is separated according to size, wherein aluminium hydroxide fines are separated out and crystallised aluminium hydroxide is obtained as product, in particular crystallised aluminium hydroxide, wherein at least 79 wt. % of the particles have a particle size of 0.15 mm (Tyler mesh 100) to 44 μm (Tyler mesh 325).

3. The method according to claim 1, wherein the entire first aluminium hydroxide precipitate is added to the second tank containing the second sodium aluminate solution.

4. The method according to claim 1, wherein the first precipitate is added to the second tank to form the supersaturated solution of sodium aluminate.

5. The method according to claim 1, wherein the second tank contains the supersaturated solution of sodium aluminate and the first precipitate is used for seeding to support precipitation in the second tank.

6. The method according to claim 1, wherein a fraction from the second precipitate is used for seeding to support precipitation in the second tank.

7. The method according to claim 1, wherein at least a fraction of the second precipitate is seeded to the first tank.

8. The method according to claim 2, wherein after the separation of the second precipitate according to size at least a fraction of the aluminium hydroxide fines are seeded into the first tank.

9. The method according to claim 2, wherein after separation of the second precipitate according to size a fraction of the product particles is seeded into the first tank.

10. The method according to claim 1, wherein the first precipitate is separated according to size, wherein aluminium hydroxide fines are separated out and a further crystallised aluminium hydroxide is obtained as product, in particular a further crystallised aluminium hydroxide, wherein at least 79 wt. % of the particles have a particle size of 0.15 mm (Tyler mesh 100) to 44 μm (Tyler mesh 325).

11. The method for the production of aluminium oxide, wherein aluminium hydroxide is obtained according to claim 1, wherein said aluminium hydroxide is calcinated.

12. The method according to claim 11, wherein crystallised aluminium hydroxide is obtained according to claim 2, and wherein the crystallised aluminium hydroxide is calcinated.

13. The method according to claim 11, wherein at least a fraction of the first precipitate is calcinated, in particular the further crystallised aluminium hydroxide.

14. The method according to claim 11, wherein aluminium hydroxide fines contained in the gas stream exiting the calciner are added to the first tank.

15. The method according to claim 11, wherein aluminium hydroxide fines contained in the gas stream exiting the calciner are added to the second tank.
